(19) United States
(12) Patent Application Publication
(10) Pub. No.: US 2014/0035888 A1
(43) Pub. Date: Feb. 6, 2014

(54) FOOT-OPERATED CONTROLLER FOR CONTROLLING A MACHINE

(71) Applicants: Luc Levasseur, Montreal (CA); Stéphane Rivard, Montreal (CA)

(72) Inventors: Luc Levasseur, Montreal (CA); Stéphane Rivard, Montreal (CA)

(73) Assignee: STELULU TECHNOLOGY INC., Montreal, QC (CA)

(21) Appl. No.: 13/978,394

(22) PCT Filed: Jan. 5, 2012
(86) PCT No.: PCT/CA12/00021

§ 371 Date: Oct. 23, 2013

Related U.S. Application Data
(60) Provisional application No. 61/429,786, filed on Jan. 5, 2011.

(51) Int. Cl. G06F 3/033

(52) U.S. Cl. CPC G06F 3/0334
USPC 345/184

(57) ABSTRACT

A foot-operated controller for controlling a machine, comprising: a foot-receiving platform comprising a foot-receiving member and a base to be deposited on a receiving surface, the foot-receiving member having a first member end for receiving a foot of a user, the base protruding from a second opposite member end of the foot-receiving member, the base and the receiving surface forming a pivot joint for rocking the foot-receiving platform relative to the receiving surface in at least one direction; at least one sensor for detecting at least one rocking movement of the foot-receiving platform relative to the receiving surface in the at least one direction; and a communication interface unit for transmitting to the machine a respective command upon detection of the at least one rocking movement, the foot-operated controller being connectable to a power source for powering at least the at least one sensor.

### CROSS-REFERENCE TO RELATED APPLICATIONS

This application claims priority of U.S. Provisional Patent Application having Ser. No. 61/429,786, which was filed on Jan. 5, 2011 and is entitled “Haptic interface”, the specification of which is hereby incorporated by reference.

### TECHNICAL FIELD

The present invention relates to the field of controllers for controlling a machine, and more particularly to foot-operated controllers.

### BACKGROUND

Hand-operated controllers such as keyboards and joysticks are usually used for controlling machines such as computers and video game consoles for example. However, hand-operated controllers may not be adapted for some people such as people suffering hand/arm disabilities or having limited range or flexibility of finger movement, for example.

In addition, even able people may experience some difficulty in using a hand-operated controller or performing adequately while using a hand-operated controller. For example, video game players may experience some difficulties or limited performances while using a usual hand-operated controller. Video games have become more sophisticated and complex. Users may be required to perform many functions simultaneously via a keyboard, a mouse, and/or a joystick in order to become competitive. Some games such as World of Warcarft™ for example require the users to memorize over 25 keys in order activate various functions such as casting spells (up to 10 different types), pulling maps for navigation, activating a headset for talking, organizing raids (going into battle), and the like. However, the number of functions that may be performed simultaneously by the user is limited since a user only has two hands and ten digits.

Therefore, there is a need for an improved controller for controlling a machine to be used alone or in combination with another controller.

### SUMMARY

There is described a foot-operated controller or pedal controller for controlling a machine, such as a video game machine or a computer for example. The foot-operated controller is adapted to receive a foot of a user who may send commands to the machine while having his foot resting on the foot-operated controller.

The foot-operated controller comprises a platform adapted to receive the foot of the user. The platform comprises a foot-receiving portion on which the foot of the user rests, and a base protruding downwardly from the foot-receiving portion. When the foot-operated controller is deposited on a receiving surface, such as a floor for example, the base rests on the receiving surface. The base and the receiving surface form a pivot joint about which the platform may rock/tilt/pivot. The foot-operated controller further comprises at least one movement sensor adapted to detect and/or measure at least one rocking/tilting/pivot movement of the foot-receiving platform, i.e. a rocking/tilting/pivot movement in at least one given direction. Such a rocking/tilting/pivot movement triggers the transmission of a respective command by a communication interface unit. The command is sent to the machine which interprets the command as an input and executes a predefined action corresponding to the received input.

In accordance with a broad aspect, there is provided a foot-operated controller for controlling a machine, comprising: a foot-receiving platform comprising a foot-receiving member and a base to be deposited on a receiving surface, the foot-receiving member having a first member end for receiving a foot of a user and a second member end opposite to the first member end, the base protruding from the second member end of the foot-receiving member, the base and the receiving surface forming a pivot joint for rocking the foot-receiving platform relative to the receiving surface in at least one direction; at least one sensor for detecting at least one rocking movement of the foot-receiving platform relative to the receiving surface in the at least one direction; and a communication interface unit secured to the foot-receiving platform and operatively connected to the at least one sensor for transmitting to the machine a respective command upon detection of the at least one rocking movement, the foot-operated controller being connectable to a power source for powering at least the at least one sensor.

In one embodiment, the at least one sensor comprises a single position sensor integrated within the foot-receiving platform for detecting one of a position and a position variation for a reference point of the foot-receiving platform.

In another embodiment, the at least one sensor comprises a plurality of switches each located at a different location on the foot-receiving platform and each activatable upon a corresponding one of the at least one rocking movement of the foot-receiving platform in a corresponding one of the at least one direction.

In one embodiment, the switches each protrude from the second member end of the foot-receiving member.

In another embodiment, the switches each protrude from the base of the foot-receiving member.

In one embodiment, each one of the plurality of switches comprises a push button switch activatable upon abutment on the receiving surface.

In one embodiment, the foot-operated controller further comprises at least one elastic member having one end secured to one of the base and the foot-receiving member, and an opposite end to rest on the receiving surface.

In one embodiment, the at least one elastic member comprises at least one spring.

In one embodiment, a cross-sectional surface area of the base decreases from the second member end of the foot-receiving member.

In one embodiment, the base has a hemispherical shape.

In one embodiment, the respective command is indicative of a discrete input for the machine.

In another embodiment, the respective command is indicative of a continuous input for the machine.

In one embodiment, the communication interface unit comprises a processing unit, a storing unit, and communication means.

In one embodiment, the communication means comprises a connector.

In another embodiment, the communication means comprises a wireless communication device.

In one embodiment, the storing unit is adapted to store thereon a database comprising one of a corresponding code and a corresponding macro for each one of the at least one direction, the processing unit being configured for transmitting the one of a corresponding code and a corresponding macro upon detection of at the least one rocking movement of the foot-receiving platform via the communication means.

In accordance with another embodiment, there is provided a foot-operated controller for controlling a machine, comprising: a rockable platform for receiving a foot of a user and to be deposited on a receiving surface, the rockable platform being movable between a default position and at least one tilted position relative to the receiving surface; at least one sensor secured to the rockable platform for detecting the at least one tilted position of the foot-receiving platform; and a communication interface unit integrated within the rockable platform and operatively connected to the at least one sensor for transmitting to the machine a respective command upon detection of the at least one tilted position, the foot-operated controller being connectable to a power source for powering at least the at least one sensor.

In one embodiment, the at least one sensor comprises a plurality of switches each for detecting a respective one of the at least one tilted position.

In one embodiment, the communication interface unit is adapted to transmit a corresponding switch identification upon activation of the switches.

In one embodiment, the communication interface unit is adapted to transmit one of a corresponding code and a corresponding macro upon activation of the switches.

A discrete input is an input which is informative of a single state of a device and/or triggers a discrete action. For example, a discrete input can be informative of an on or off state of a device such as a switch for example. A discrete command sent by a device such as a switch for example is informative of a single state for the device, such as an on or off state. A discrete command may also correspond to a single code for example. A discrete command is sent at a discrete point in time. A discrete command corresponds to a discrete input, i.e. a machine receiving a discrete command interprets it as a discrete input. For example, a depression of a key of a keyboard triggers a discrete command which is interpreted by a computer as a discrete input. A discrete input may also be an on/off input.

A discrete input differs from a continuous input. Examples of continuous inputs comprise an input generated by a mouse, an input generated by a joystick, and the like. In the case of a computer mouse, the continuous input may correspond to a position change for the mouse which is sent by the mouse to a computer which updates the position of a cursor accordingly. For example, the continuous input for a mouse may comprise two states: a position change according to a first axis, and a position change according to a second and different axis. In the case of a joystick, the continuous input may comprise at least two states, i.e. the state of the at least two degrees of freedom of the joystick.

### BRIEF DESCRIPTION OF THE DRAWINGS

Further features and advantages of the present invention will become apparent from the following detailed description, taken in combination with the appended drawings, in which:

FIG. 1 is a block diagram illustrating a system comprising a machine controlled by a foot-operated controller, in accordance with an embodiment;

FIG. 2A is a side view of a pedal controller provided with an inverse-and-truncated pyramidal base in a neutral/default position, in accordance with an embodiment;

FIG. 2B is a bottom view of the pedal controller of FIG. 2A;

FIG. 2C is a top view of the pedal controller of FIG. 2A;

FIG. 2D is a side view of the pedal controller of FIG. 2A when in an activated position, in accordance with an embodiment;

FIG. 3A is a side view of a pedal controller provided with a base formed of three hemispherical members, in accordance with an embodiment;

FIG. 3B is a bottom view of the pedal controller of FIG. 3A;

FIG. 4 is a side view of a pedal controller provided with springs, in accordance with a second embodiment;

FIG. 5 is a side view of a pedal controller provided with a cubic base, in accordance with an embodiment;

FIG. 6 is a side view of a pedal controller provided with a truncated pyramidal base, in accordance with an embodiment;

FIG. 7A is a plan view of a controller pad according to a first embodiment;

FIG. 7B is a side elevation view of the controller pad of FIG. 7A;

FIG. 7C is a bottom view of the controller pad of FIG. 7A;

FIG. 7D is a side cross-sectional view of the controller pad of FIG. 7A;

FIG. 8A is a plan view of a controller pad according to a second embodiment;

FIG. 8B is a side elevation view of the controller pad of FIG. 8A;

FIG. 8C is a bottom view of the controller pad of FIG. 8A;

FIG. 8D is a side cross-sectional view of the controller pad of FIG. 8A;

FIG. 9A illustrates a controller pad provided with eight buttons positioned according to a first configuration, in accordance with an embodiment;

FIG. 9B illustrates a controller pad provided with a curved base, in accordance with an embodiment;

FIG. 9C illustrates a controller pad provided with eight buttons positioned according to a second configuration, in accordance with an embodiment;

FIG. 10A is a cross-sectional view of a controller pad provided with rotational motion detection, in accordance with an embodiment;

FIG. 10B is a top view of the controller pad of FIG. 10A;

FIG. 11A is a cross-sectional view of a controller pad provided with location sensor across a full controller pad upper surface, in accordance with an embodiment;

FIG. 11B is a top view of the controller pad of FIG. 11A;

FIGS. 12A and 12b are cross-sectional views of a controller pad wherein a lower surface button supports continuous activation and continuous tilt feedback, respectively, in accordance with an embodiment;

FIG. 13A is a cross-sectional view of a controller pad provided with location sensor across a portion of a controller pad upper surface, in accordance with an embodiment;

FIG. 13B is a top view of the controller pad of FIG. 13A;

FIG. 14 depicts some combinations of a controller pad interfacing to a gaming console, in accordance with an embodiment; and

FIG. 15 presents an exemplary flow chart for a gaming console interacting with a controller pad according to an embodiment.

It will be noted that throughout the appended drawings, like features are identified by like reference numerals.

### DETAILED DESCRIPTION

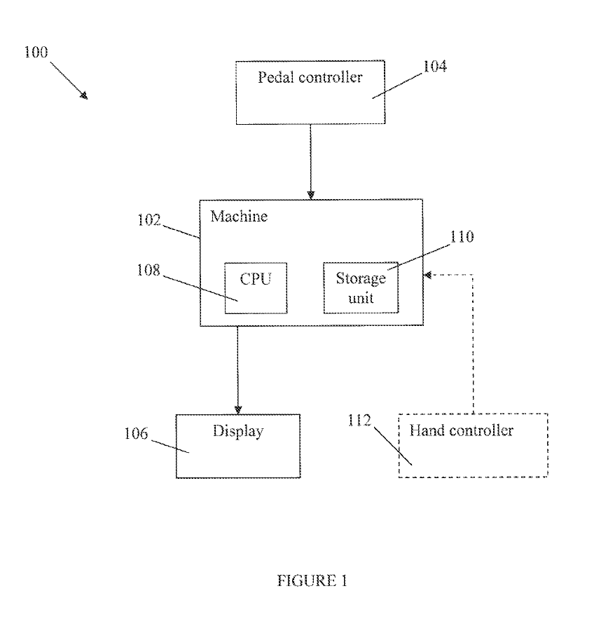

FIG. 1 illustrates one embodiment of a computer system 100 comprising a machine to be controlled, a foot-operated or pedal controller 104, and a display unit 106. The machine 102 comprises a processing unit 108, a storage unit 110, and a communication unit (not shown) for communicating at least with the pedal controller 104 and the display unit 106.

The pedal controller 104, which is described in more detail below, is sized and shaped to receive substantially a whole foot of a user of the system 100. The pedal controller 104 is deposited on a receiving surface, such as a floor for example, and comprises at least one sensor adapted to detect at least one rocking/tilting/pivot movement of the pedal controller 104 relative to the receiving surface. The detection of a given rocking/tilting/pivot movement, i.e. a rocking/tilting/pivot movement in a given direction, triggers the transmission of a respective command to the machine 102. During operation of the pedal controller 104, substantially the whole foot of the user rests on the pedal controller 104. The user does not have to lift any part of his foot to rock/tilt/pivot the pedal controller 104 with respect to the receiving surface, and therefore to send commands to the machine 102.

In one embodiment, the pedal controller 104 comprises at least two movement sensors each adapted to detect a corresponding rocking/tilting/pivot movement. In this case, a respective command corresponding to a respective action to be executed by the machine 102 is associated with each movement sensor.

In another embodiment, the pedal controller 104 comprises a single movement sensor adapted to detect at least one rocking/tilting/pivot movement, and a respective command corresponding to a respective action to be executed by the machine 102 is associated with each rocking/tilting/pivot movement.

In a further embodiment, the pedal controller 104 comprises a plurality of movement sensors adapted to cooperate together in order detect at least one rocking/tilting/pivot movement, and a respective command corresponding to a respective action to be executed by the machine 102 is associated with each rocking/tilting/pivot movement.

In one embodiment, the pedal controller 104 is adapted to send at least one discrete command to the machine 102. The machine 102 interprets the discrete command received from the pedal controller 104 as a discrete input, and executes a predefined action corresponding to the discrete input. The action may comprise the execution of a given code or a given macro corresponding to a sequence of codes. A code may comprise a sequence of natural numbers, octets, electrical pulses, or the like. For example, a code may be represented by an American Standard Code for Information Interchange (ASCII) code.

In another embodiment, the pedal controller 104 is adapted to send at least one continuous command to the machine 102. The machine 102 interprets the continuous commands as a continuous input, and executes a predefined action corresponding to the continuous input. For example, the action may comprise moving a cursor. The pedal controller 104 then acts a mouse. As a result, when the pedal controller 104 is rocked in a given direction, the cursor is moved in a corresponding direction. In another embodiment, the pedal controller 104 may act as a joystick for controlling an entity in a video game for example. In this case, when the pedal controller 104 is rocked in a given direction, the entity is moved in a corresponding direction within the video game environment.

It should be understood that the pedal controller 104 may be adapted to send both discrete and continuous commands. For example, a first pedal controller movement, i.e. a rocking/tilting/pivot movement in a first direction, may be associated with a discrete command while a second pedal controller movement, i.e. a rocking/tilting/pivot movement in a second direction, may be associated with a continuous command.

In one embodiment, the movement sensor may be adapted to determine the amplitude, acceleration, and/or speed of the rocking/tilting/pivot movement of the pedal controller 104, and/or the force exerted by the user to generate the rocking/tilting/pivot movement. In this case, the action corresponding to a given rocking/tilting/pivot movement may be representative of the acceleration, speed, amplitude, and/or exerted force. For example, the displacement amplitude of a cursor or a video game entity may be proportional to the amplitude of the rocking/tilting/pivot movement. In another embodiment, the amplitude, acceleration, speed, and/or force is used for determining the command to be sent to the machine 102. For example, a rocking/tilting/pivot movement having a first amplitude in a given direction may be associated with a first command while a rocking/tilting/pivot movement having a second and different amplitude in the same given direction may be associated with a second and different command. In this case, a given rocking/tilting/pivot movement corresponding to a given action to be performed is defined by a corresponding rocking direction and a corresponding amplitude, acceleration, speed, and/or force.

Before using the pedal controller 104, a user has to associate a respective action to be performed for each rocking/tilting/pivot movement of the pedal controller 104. The pedal controller 104 comprises a communication interface unit for communicating with the machine 102. The communication interface unit may be physically connected to the machine 102 to be controlled via a cable for electric, electronic, or optical communication. In another example, the communication interface unit may be adapted for wirelessly communicating with the machine 102.

In one embodiment, the pedal controller 104 is adapted to send continuous commands to the machine 102. In one embodiment, a continuous command may be indicative of a three dimensional (3D) or a two dimensional (2D) position variation for a reference point, such as the gravity center of the pedal controller 104 for example. In this case, the pedal controller 104 may be provided with a single movement sensor adapted to determine the 3D or 2D position variation of the reference point. In another embodiment, the pedal controller 104 is provided with a plurality of movement sensors located at different locations on the pedal controller 104 and each associated with a respective rocking/tilting/pivot movement, i.e. a respective movement direction. In this case, each movement sensor may be adapted to detect a one dimensional (1D) or 2D position variation. When the pedal controller 104 is rocked in a given direction, the corresponding movement sensor determines a 1D or 2D position variation for the pedal controller 104, such as a movement amplitude for example, and the continuous command is indicative of the movement amplitude. The continuous command may also comprise an identification of the movement sensor that detected the rocking/tilting/pivot movement or an identification of the direction in which the pedal controller 104 is rocked/tilted/pivoted. The position variation and the identification of the sensor or the direction form a continuous input for the computer 102.

Upon reception of the continuous command, the processing unit of the machine 102 determines the action to be executed which corresponds to the received continuous command, and executes the action. For example, the storage unit 110 of the machine 102 may comprise a database of actions to be executed and corresponding commands. Upon reception of a given command, the processing unit 108 of the machine retrieves the corresponding action from the database, and executes the corresponding action.

In another embodiment, the communication interface unit of the pedal controller 104 is adapted to determine the action to be executed corresponding to the detected rocking/tilting/pivot movement, and the transmitted command is indicative of the action which is then executed by the machine 102. In this case, the communication interface unit is provided with a processing unit adapted to determine the action to be executed and a storing unit. For example, the storage unit of the communication interface unit may comprise a database of actions to be executed and corresponding rocking/tilting/pivot movements. Upon detection of a given rocking/tilting/pivot movement, the processing unit of the communication interface unit retrieves the corresponding action from the database, and transmits a command indicative of the corresponding action to the machine 102.

In one embodiment, each rocking/tilting/pivot movement is associated with a respective discrete command. The pedal controller may comprise a single movement sensor adapted to determine the direction of the rocking/tilting/pivot movement or the position variation of a reference point. Alternatively, the pedal controller may be provided with a plurality of movement sensors each associated with a respective movement direction. In this case, a given direction of movement may be identified by an identification of the corresponding movement sensor.

In one embodiment, the communication interface unit is adapted to transmit a discrete command indicative of the movement direction, the position variation, and/or the movement sensor identification (ID), and the machine 102 is adapted to determine the discrete action corresponding to the received discrete command, and to execute the discrete action. In another embodiment, the communication interface unit may be adapted to determine the action to be executed which corresponds to the determined movement direction, the 3D position variation, and/or movement sensor identification. In this case, the discrete command sent by the communication interface unit is then indicative of the action to be executed by the computer 102.

In one embodiment, the pedal controller 104 comprises at least one switch positioned at different locations on the pedal controller 104. Each switch is associated with a respective rocking/tilting/pivot movement, i.e. a respective movement direction.

In one embodiment, the discrete command sent by the pedal controller 104 upon activation of a corresponding switch is an on signal. In this case, the communication interface unit of the pedal controller 104 may comprise a connector having a different connector port for each switch and the machine is provided with a matching connector. The machine determines which switch has been activated by identifying the connector port from which the discrete command has been received. The machine 102 then executes the corresponding action. In this case, the machine 102 comprises a database stored on the storage unit or memory 110, which comprises a respective action, such as a code or a macro for example, to be executed for each connector port. It should be understood that different on or off signal format may be used. For example, an off signal may correspond to the transmission of no signal. In another example, an on signal may correspond to a signal having a first intensity while an off signal corresponds to a signal having a second and different intensity.

In another embodiment, the communication interface unit of the pedal controller is adapted to transmit the identification of the switch that has been activated. In this case, the machine 102 comprises a database stored on the storage unit 110, which comprises a respective action, such as a code or a macro for example, to be executed for each switch ID.

In a further embodiment, the discrete command sent by the communication interface unit of the pedal controller 104 is a code or a macro to be executed by the machine 102. In this case, the communication interface unit is provided with a storage unit comprising a corresponding code/macro for each switch, and a processing unit. Upon activation of a given switch, the communication interface unit is adapted to determine the code/macro corresponding to the activated switch and transmit the corresponding code/macro to the machine 102.

In still a further embodiment, the communication interface unit is adapted for wireless communication with the machine to be controlled. For example, the communication interface unit and the machine may communicate via Radio Frequency (RF), Bluetooth™, or the like. The communication interface unit may be adapted to send a corresponding switch ID upon activation of a given switch or a corresponding code/macro.

In one embodiment, a pedal controller 104 adapted to transmit discrete commands may be used in replacement of a usual discrete input device such as a keyboard for example. For example, people suffering disabilities preventing them to use a keyboard may use the pedal controller 104 in replacement of a keyboard. For example, the system 100 may be programmed so that the activation of each switch of the pedal controller 104 triggers a same action as the one triggered by the depression of a corresponding keyboard key. In another embodiment, a pedal controller 104 adapted to send continuous commands may be used in replacement of a usual continuous input device such as a joystick, for example.

In another embodiment, the pedal controller 104 may be used in association and/or concurrently with a usual controller such as a hand-operated controller 112, e.g. a joystick, a keyboard, or the like. In this case, the user is able to perform a greater number of concurrent actions using the pedal controller 104 and the hand-operated controller 112 than he would perform using only the hand-operated controller. For example, a user playing a video game may operate a hand-operated joystick or a keyboard to navigate a character in the video game while using the pedal controller 104 for performing actions such as casting spells, pulling maps for navigation, activating a headset for talking, even for organizing a raid (going into battle), and/or the like.

In one embodiment, the user may operate the pedal controller 104 without having to lift any part of his foot from the pedal controller, i.e. substantially the whole foot of the user may rest on the pedal controller 104 during the operation of the pedal controller 104. For example, the user does not have to depress push buttons located at different locations using his toe(s) or forefoot, and he does not have to lift his foot from a first push button located at a first location, move his foot up to a second push button located at a second and different location, and then depress the second push button. Therefore, the use of the pedal controller 104 allows for quicker execution time, less or substantially no user fatigue, and/or increased functionality and performance.

The machine 102 may be any adequate device provided with a processing unit, a storage unit, and communication means. For example, the machine 102 may be a computer. The machine 102 may also be a video game console such as a PlayStation 3™, a Wii™, an Xbox 360™, etc.

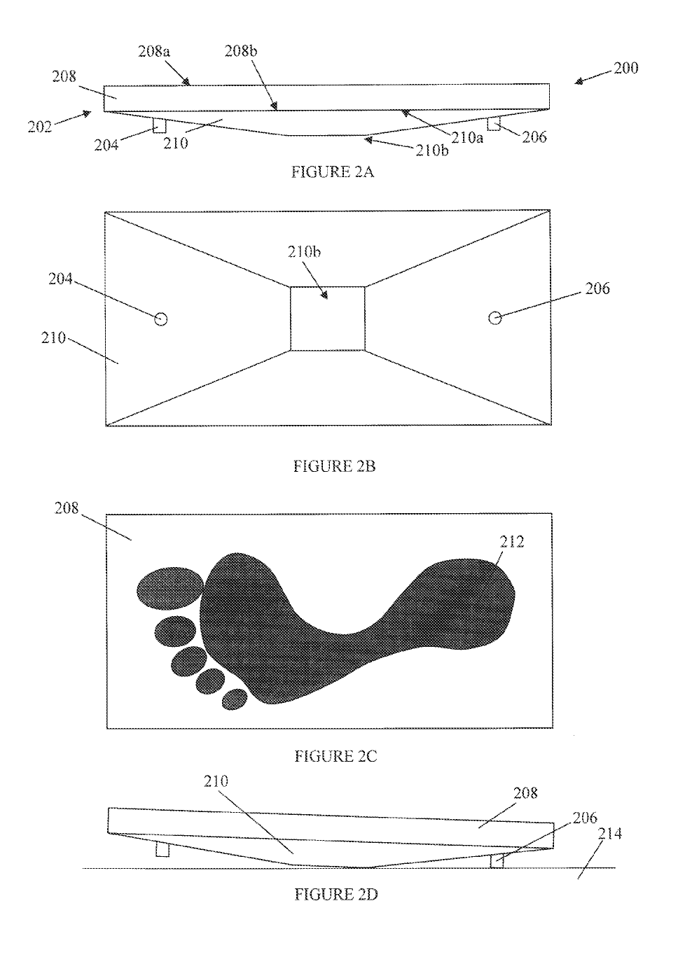

Referring to FIGS. 2A, 2B, and 2C, there is illustrated one embodiment of a foot-operated or pedal controller 200 adapted to control a machine such as machine 102 for example. The pedal controller 200 comprises a rockable platform 202, two movement sensors 204 and 206, and a communication interface unit (not shown).

The rockable platform 202 comprises a foot-receiving member 208 in the form of a top plate, and a base 210 protruding downwardly from the top plate 208. The top plate 208 extends between a top end 208a and an opposite bottom end 208b. The top plate 208 is sized and shaped for receiving substantially a whole foot of a user on its top end 208a. The base 210 extends from a top end 210a and a bottom end 210b. The top end 210a of the base 210 is secured to the bottom end 208b of the top plate 208. The bottom end 210b is adapted to be deposited on a receiving surface, such as a floor for example.

The base 210 has the shape of an inverse-and-truncated pyramid so that its cross-sectional surface area decreases from the top end 210a to the bottom end 210b. Since the bottom end 210b of the base 210, which is to rest on the receiving surface, has a surface area that is less than the top end 208a of the top plate 208, which is to receive the foot of the user, the rockable platform 202 may rock/tilt/pivot relative to the receiving surface. The base 210 and the receiving surface form together a joint mechanism about which the platform 202 may rock/tilt/pivot.

The movement sensors 204 and 206 are each adapted to detect a corresponding rocking/tilting/pivot movement of the rockable platform 202. The movement sensors 204 and 206 are adjacent to the front end and the rear end of the pedal controller 200, respectively. Each movement sensor 204 and 206 comprises a switch which projects downwardly from the base 210 so as to be activated upon abutment thereof on the surface. The movement sensors are operatively connected to the communication interface unit so that a respective discrete command is sent to the machine to be controlled.

While FIG. 2A illustrates the pedal controller 200 in a neutral/default position in which no command is sent to the machine to be controlled, FIG. 2D illustrates the pedal controller 200 in an activated position. By rocking the pedal controller 200 in a rearward motion, the switch 206 abuts the receiving surface 214 and activates. The activation of the switch 206 triggers the transmission of a first command to the machine to be controlled. Similarly, by rocking the pedal controller 200 in a forward motion, the switch 204 is activated and a second command is transmitted to the machine to be controlled.

Because of the inverse-and-truncated pyramidal shape of the base 210, the pedal controller may be further provided with a left movement sensor switch and a right movement sensor switch projecting downwardly from the base 210 adjacent to the left end and the right end of the pedal controller 200, respectively. In this case, four different rocking/tilting/pivot movements, i.e. a rocking/tilting/pivot movement in four different directions, may be selectively performed by the pedal controller 200 in order to activate four different movement sensor switches and transmit four different commands to the machine.

It should be understood that the characteristics of the base, such as its shape and size, may vary as long as the base allows to support the top plate 208 in a stable position when the pedal controller 200 is in the neutral/default position, and allows at least one rocking/tilting/pivot movement of the top plate 208 with respect to the receiving surface on which the pedal controller is deposited.

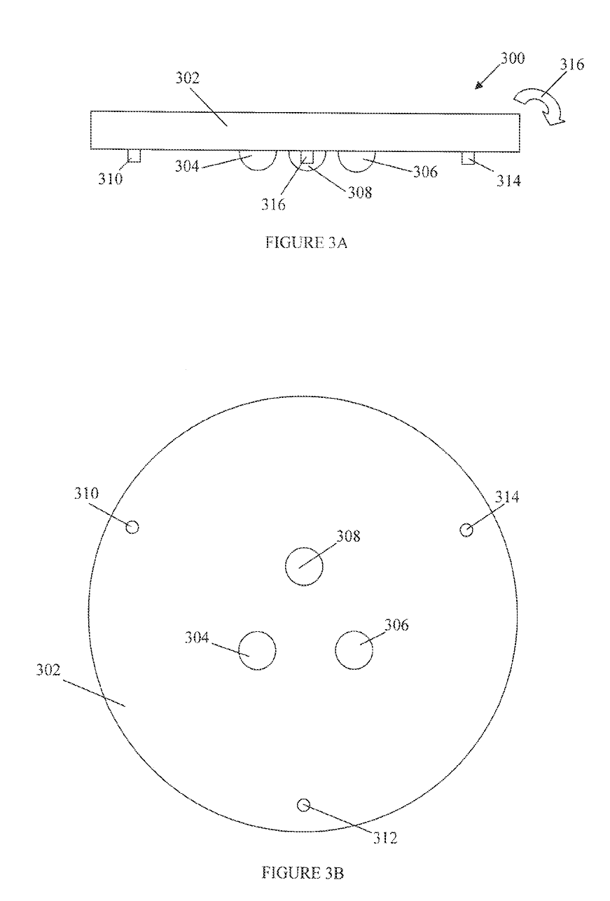

FIGS. 3A and 3B illustrates one embodiment of a pedal controller 300 comprising a cylindrical top plate 302, a base formed from three pivot members 304, 306, and 308 projecting from the top plate 302, three movement sensor switches 310, 312, and 314, and a communication interface unit (not shown). Each pivot member 304, 306, 308 is provided with a hemispherical shape, and two given ones of the three pivot members 304, 306, and 308 cooperate together for rocking/tilting/pivoting the pedal controller 300 in a respective direction and therefore activating a respective one of the three movement sensor switches 310, 312, and 314.

For example, the pivot members 306 and 308 form a pivot for rocking the pedal controller in the direction of arrow 316. By rocking/tilting/pivoting the pedal controller 300 about the pivot formed by the pivot members 306 and 308, the movement sensor switch 314 is activated and a respective command is transmitted by the communication interface unit.

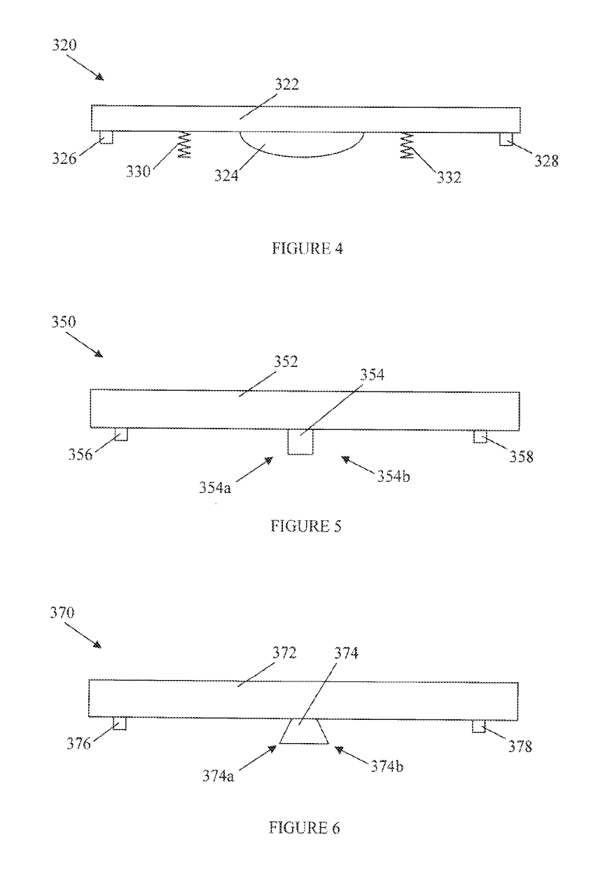

FIG. 4 illustrates one embodiment of a pedal controller 320 comprising a foot-receiving top plate 322, an ellipsoidal base 324, two movement sensor switches 326 and 328, two springs 330 and 332, and a communication interface unit (not shown). Each spring 330 and 332 has one end secured to the bottom end of the top plate 322 and an opposite end engageable with a receiving surface on which the pedal controller 320 is to be deposited, and is located between the ellipsoidal base 324 and the movement sensor switch 330 and 332, respectively.

The ellipsoidal base 324 allows the pedal controller 420 to rock/tilt/pivot with respect to the receiving surface on which it is deposited in a plurality of directions, including frontwardly for activating the movement sensor 326 and rearwardly for activating the movement sensor switch 328.

In one embodiment, the presence of the springs 330 and 332 allows for bringing back the pedal controller 320 in its initial position after the user stopped exerting a force on the pedal controller 320. Therefore, substantially no effort has to be made by the user for bringing back the pedal controller 320 in its neutral/default position in comparison to the use of a balance board for example, which also reduces the user fatigue. Furthermore, while the balance board requires a user to be in a sitting position in order to balance the top plate of the board, the above-described pedal controller may be used in both a sitting and a standing position. In addition, the pedal controller requires the use of a single foot for operation.

It should be understood that the number, size, and/or location of the springs 330 and 332 may vary. While the present description refers to springs 330 and 332, it should be understood that any adequate elastic/resilient device may be used. For example, the springs 330 and 332 may be replaced by adequate resilient foam pads. It should also be understood that the springs 320 and 322 may be integrated in the movement sensor switches 326 and 328, respectively.

While the above-described pedal controllers are provided with a base having a cross-sectional surface area decreasing from the end secured to the top plate to the opposite end to rest on the receiving surface, it should be understood that the base may be provided with any other adequate shape allowing the pedal controller to rock/tilt/pivot relative to the receiving surface, as described in the following examples.

FIG. 5 illustrates one embodiment of a pedal controller 350 comprising a foot-receiving top plate 352, a cubic base 354, two movement sensor switches 356 and 358, and a communication interface unit (not shown). The base 354 acts as a pivot about which the pedal controller 350 may rock/tilt/pivot in at least two different directions. For example, when the pedal controller 350 is rocked in a frontward motion, the end 354a of the base 354 acts as a pivot point and the movement sensor switch 356 is activated, thereby triggering the transmission of a corresponding command. Similarly, when the pedal controller 350 is rocked in a rearward motion, the end 354b of the base 354 acts as a pivot point and the movement sensor switch 358 is activated, thereby triggering the transmission of a corresponding command.

FIG. 6 illustrates one embodiment of a pedal controller 370 comprising a foot-receiving top plate 372, a truncated pyramidal shaped base 374, two movement sensor switches 376 and 378, and a communication interface unit (not shown). The base 374 forms a pivot about which the pedal controller 370 may rock/tilt/pivot in at least two different directions. For example, when the pedal controller 370 is rocked in a frontward motion, the end 374a of the base 374 acts as a pivot point and the movement sensor switch 376 is activated, thereby triggering the transmission of a corresponding command. Similarly, when the pedal controller 370 is rocked in a rearward motion, the end 374b of the base 374 acts as a pivot point and the movement sensor switch 378 is activated, thereby triggering the transmission of a corresponding command.

It should be understood that the number and location of the above-described switches may also vary as long as the pedal controller comprises at least one switch. The number of switches depends on the number of possible actions that may be triggered using the pedal controller. The switches may extend from the foot-receiving plate or the base, as illustrated above with respect to FIGS. 2A and 3A for example.

The expressions “front end”, “rear end”, “left end”, and “right end” should be understood in the context where the foot of a user rests on the pedal controller. For example, the front end of the pedal controller corresponds to the end thereof being adjacent to the forefoot of the user. Similarly, the rear end of the pedal controller corresponds to the end thereof that is adjacent to the hindfoot of the user.

It should be understood that the above-described pedal controller is connectable to a source of power for powering the movement sensors and/or the communication interface unit. For example, the pedal controller may be connectable to an external power source. In another example, the pedal controller is powered by the machine to which it is connected via a connector. For example, the pedal controller may be powered via a USB connection with the machine. In another embodiment, the pedal controller comprises an internal power source such as a disposable battery, a rechargeable battery, etc.

In one embodiment, the base of the pedal controller is provided with anti-skid or anti-slide elements secured to its bottom end for preventing the pedal controller from moving during operation by the user.

In one embodiment, the foot-receiving member or top plate and the base of the pedal controller are integral together to form a single piece. In another embodiment, the foot-receiving member or top plate and the base of the pedal controller are independent pieces fixedly secured together.

In one embodiment, the pedal controllers illustrated in FIG. 2A through 6 are adapted to send continuous inputs. In another embodiment, they are adapted to send discrete inputs.

In one embodiment, the communication interface unit comprises a processing unit or a microcontroller, and a storing unit. The storing unit comprises a database in which each switch is associated with a corresponding code or macro. In this case, upon reception of an activation signal from a given switch, the processing unit or microcontroller is adapted to retrieve the code or macro corresponding to the given switch and transmits a discrete command indicative of the corresponding code or macro.

In another embodiment, the discrete command sent by the communication interface unit to the machine to be controlled comprises an identification of the switch that has been activated. The machine then determines the action to be executed corresponding to the switch identification. For example, the machine determines a code or macro corresponding to the received switch identification.

In one embodiment, the pedal controller allows the user to send commands to a machine while not having to lift his foot. During the operation of the pedal controller, substantially the whole foot of the user, i.e. the hindfoot, the midfoot, and the forefoot, rests on the foot-receiving plate. This allows for quicker execution time, less or substantially no user fatigue, and/or increased functionality and performance. Furthermore, the pedal controller simplifies the operation of the machine to be controlled, e.g. the pedal controller simplifies game play, operation of a computer, and the like.

In one embodiment, the foot-receiving member or top plate is substantially parallel to a floor on which the pedal controller is deposited, when the pedal controller is in its neutral/default position. Therefore, the foot-receiving top plate is substantially horizontal. As a result, when it rests on the pedal controller, the foot of the user is not inclined, i.e. the forefoot is not lifted relative to the hindfoot. As a result, the user experiences less fatigue in comparison to the use of an inclined pedal, such as a gas pedal for example.

While the above description refers to a substantially planar foot-receiving top plate, it should be understood any adequate foot-receiving member having any adequate shape and size to receive a user foot may be used.

While the pedal controller illustrated in FIGS. 2A through 6 comprises switches in the form of push buttons, it should be understood that any adequate movement sensor adapted to detect a rocking/tilting/pivot movement of the pedal controller relative to the receiving surface on which it is deposited may be used.

A switch may also be any adequate contact or proximity sensor which can be activated when a part of the foot-receiving plate abuts or approaches the receiving surface on which the pedal controller is deposited. In another embodiment, a switch may be any adequate position sensor adapted to measure the position of the foot-receiving plate relative to the receiving surface or a position variation for the foot-receiving plate. The position or position variation is sent to the communication interface unit which compares the position or the position variation to a threshold. When the position or position variation reaches the threshold, the communication interface unit transmits a discrete command indicative that the switch has been activated. Alternatively, the communication interface unit may send a continuous command indicative of the switch identification and the position or position variation.

In one embodiment, the switches may be replaced by a 2-axis accelerometer or any other adequate sensor adapted to measure the position of a reference point or a position variation for a reference point. In one embodiment, the position or the position variation is compared to a threshold for generating a discrete command. In another embodiment, a continuous command indicative of the position or position variation is generated and sent by the communication interface unit.

The switch may also be a resistance variation sensor, a capacitance variation sensor, an inductance variation sensor, a Hall effect sensor, a rotary optical encoder, a rotary variable capacitor, a rotary potentiometer, a linear optical encoder, a linear potentiometer and a strain gauge, or the like, for detecting a rocking/tilting/pivot movement of the pedal controller relative to the receiving surface on which it is deposited.

While in the embodiments illustrated in FIGS. 1 to 6, each rocking/tilting/pivot movement is associated with the activation of a single switch, it should be understood that the switches may be located so that at least two switches may be concurrently activated by a same rocking/tilting/pivot movement. For example, a pedal controller may comprise two switches located so that the first switch is activated by a back and right rocking/tilting/pivot movement or a south-east rocking/tilting/pivot movement, and the second switch is activated by a back and left rocking/tilting/pivot movement or a south-west rocking/tilting/pivot movement. Furthermore, the first and second switches may be concurrently activated by a same rocking/tilting/pivot movement, i.e. a back rocking/tilting/pivot movement or a south rocking/tilting/pivot movement.

The following presents other adequate pedal controllers that may be used in the system 100. The below described pedal controllers or controller pads each comprise a foot-receiving plate or member secured to a base to form a rockable platform, at least one movement sensor adapted to detect and/or measure a rocking/tilting/pivot movement of the pedal controller, and a communication interface unit for transmitting a command to a machine upon detection of the rocking/tilting/pivot movement. The controller pad provides according to different embodiments simple “button” type emulation whilst in other embodiments “thumb stick” emulation as well as linear motion/acceleration/rotational motion detection.

Furthermore, each below-described pedal controller is adapted to receive substantially a whole foot of the user and the user may operate the pedal controller while not lifting any part of his foot from the pedal controller.

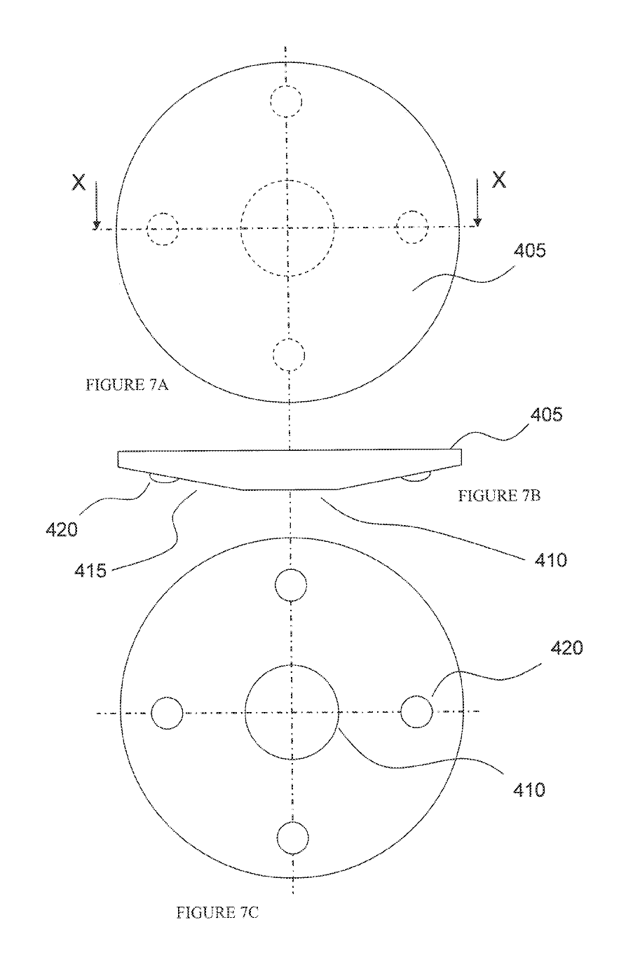

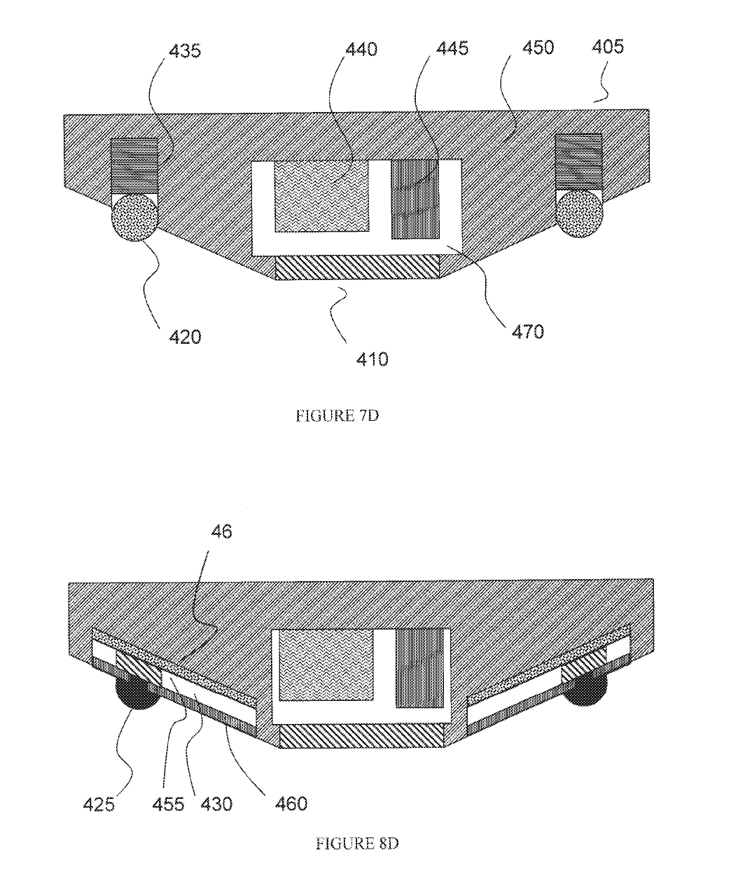

FIGS. 7A-7C illustrate a controller pad according to an embodiment in plan view, side elevation, and bottom view, respectively. As shown in FIGS. 7A and 7B, the controller pad comprises an upper surface 405. FIG. 7B shows that the lower surface of the controller pad comprises a central flat portion 410 and sloping portion 415, which together form a base. Disposed within the sloping portion 415 are buttons or movement sensors 420. As such rocking/tilting/pivoting the controller pad 400 results in part of the sloping portion 415 coming into contact with the receiving surface upon which the controller pad is placed. During the rocking/tilting/pivoting movement, a button 420 comes into contact with the surface beneath the controller pad, thereby triggering an action in dependence upon which of the buttons 420 was activated and the current state of the application the control of which is at least partially determined by the user with the controller pad.

It would be evident to one of skill in the art that the mechanisms of activating a button 420 may include physical contact, resistance variation, capacitance variation, inductance variation, proximity, Hall effect, etc.

FIG. 7D illustrates a cross-section of the controller pad of FIG. 7A. Accordingly, the controller pad comprises a body 450 having the upper surface 405 as described above in FIG. 7A. Within the body 450 is a cavity 470 which comprises circuitry 440 which includes the communication interface unit, and battery assembly 445 which are accessed through a removable plate that also forms the flat bottom portion 410. Battery assembly 445 allows the user to replace the batteries, not shown for clarity, to power the circuitry 440 that receives the outputs of the sensors 435 that connect to button 420 within the sloping portions of the controller pad. Each button 420 and a corresponding sensor 435 form together a movement sensor adapted to detect and/or measure at least one rocking/tilting/pivot movement of the pedal controller. It would be evident to one skilled in the art that the circuitry 440 may additionally comprise wireless circuitry for communicating wirelessly to the computer system executing the application or drive circuitry for driving an interface that communicates to the computer system.

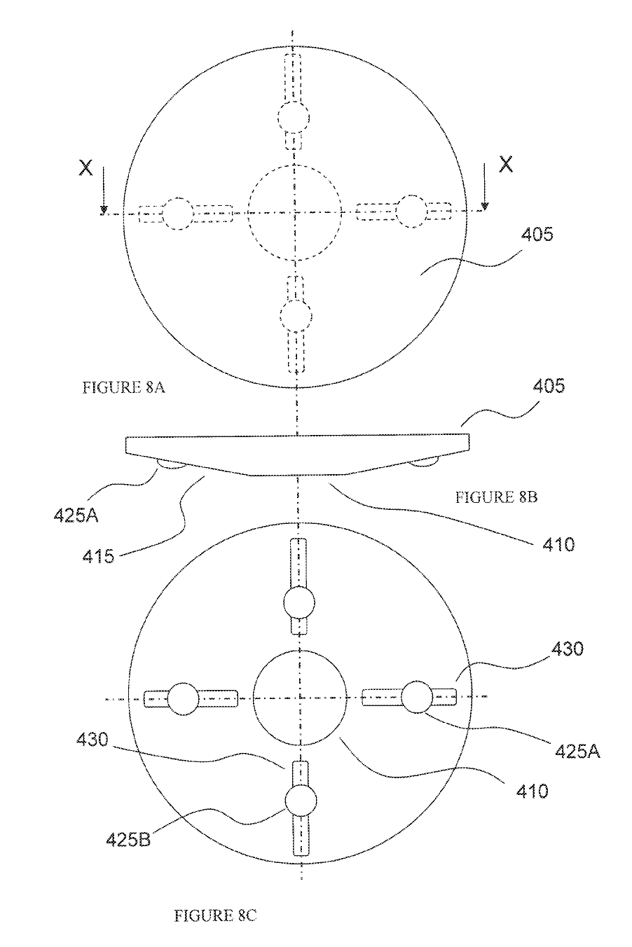

FIGS. 8A, 8B, and 8C illustrate a controller pad according to an embodiment in plan view, side elevation, and bottom view, respectively. As shown in FIGS. 8A and 8B, the controller pad comprises an upper surface 405. FIG. 8B shows that the lower surface of the controller pad comprises a central flat portion 410 and sloping portion 415 forming together a base. Disposed within the sloping portion 415 are first and second button 425A and 425B respectively that are disposed within slide guides 430. As such rocking/tilting/pivoting the controller pad results in part of the sloping portion 415 coming into contact with the receiving surface upon which the controller pad is placed. During the rocking/tilting/pivoting movement, a first or second button respectively 425A and 425B comes into contact with the surface beneath the controller pad thereby triggering an action in dependence upon which of the first and second buttons 425A and 425B was activated and the current state of the application the control of which is at least partially determined by the user with the controller pad.

As shown in FIG. 8C, the first buttons 425A are positioned further away from the central flat portion 410 than the second buttons 425B. Each of the first and second buttons 425A and 425B can be positioned within the slide guide 430 by the user allowing them to adjust the engagement of the first and second buttons 425A and 425B in terms of the amount of tilting required for activating them. First buttons 425A by being disposed towards the outer edge of the controller pad are engaged at increased tilt with respect to second buttons 425B.

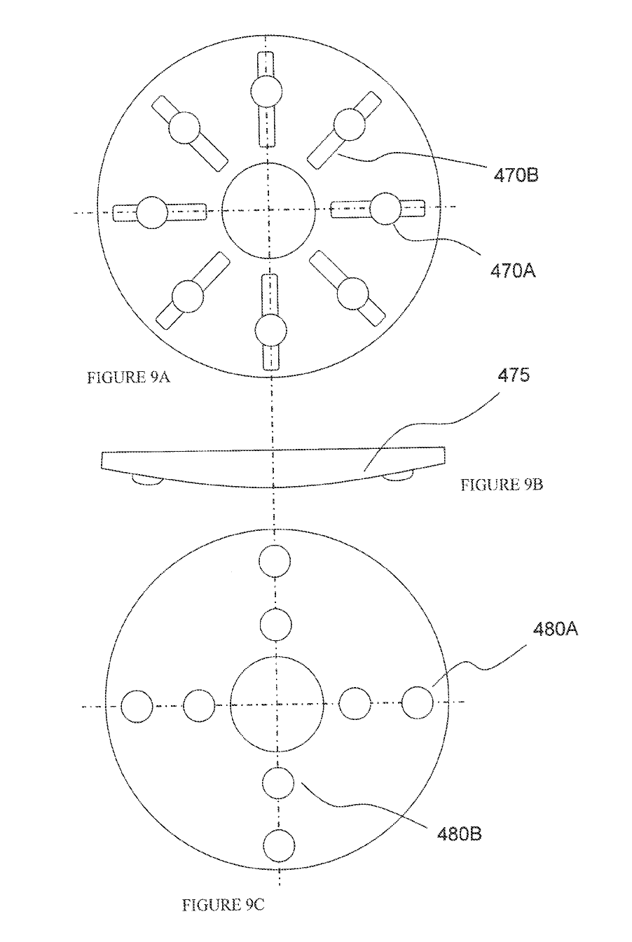

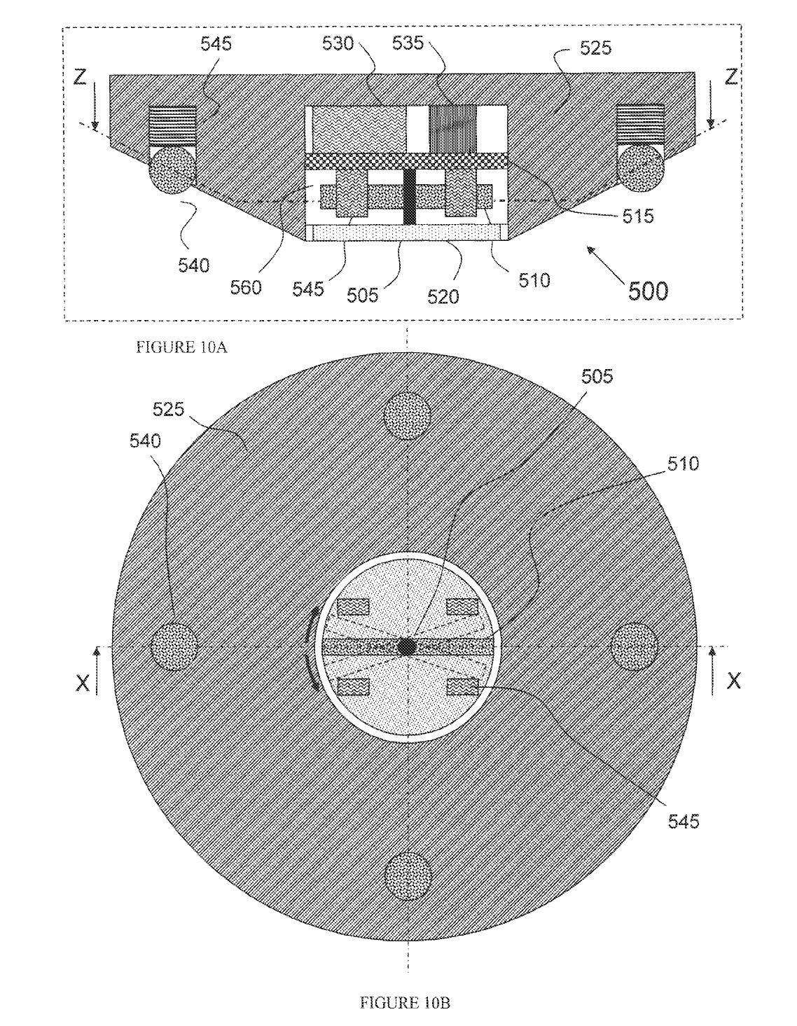

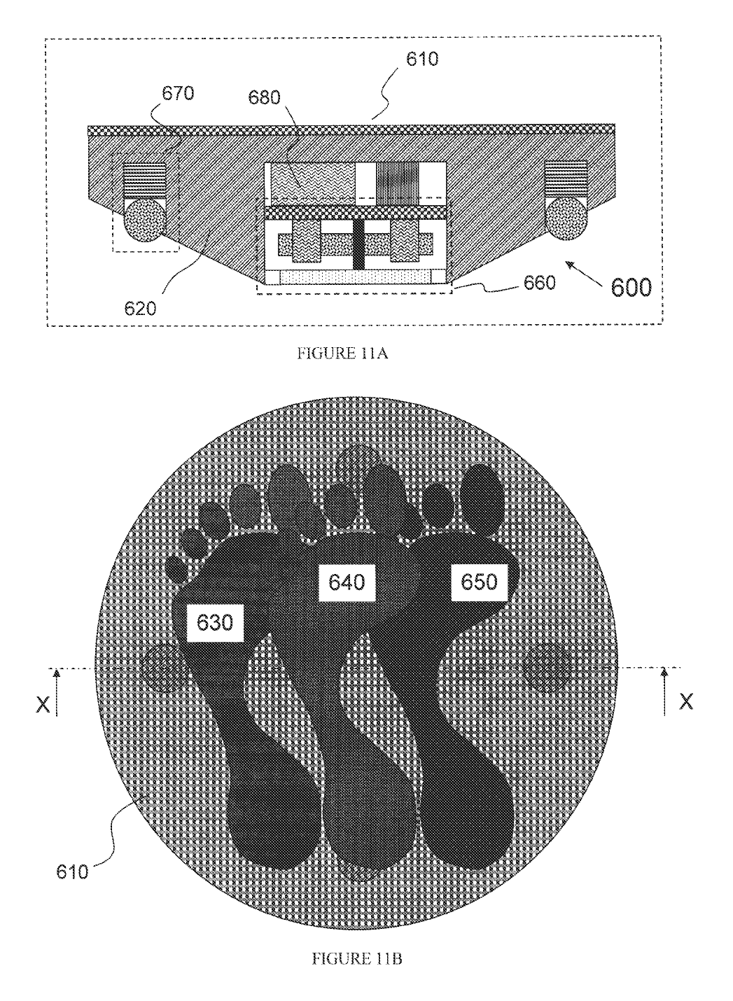

FIGS. 9A, 9B, and 9C illustrate first controller, second controller, and third controller, respectively. In FIG. 9A, there is shown a controller that comprises eight buttons 470A with sliders 470B allowing the user to adjust the first controller in different directions according to their particular requirements. It would be evident that different users may have different setting preferences allowing for increased/reduced engagement of the button 470A. Optionally the buttons 470A may be adjusted under control of electromechanical actuators that replace the sliders 470B. As such a user may establish the desired settings which are stored within memory of the first controller or computer system running the application that the controller is providing input to. As such, a user logging into the application may have the controller automatically set to their preferences, or a series of users engaged alternately in a game for example may have the controller adjusted as it is each user's turn.

FIG. 9B illustrates second controller provided with a curved base 475 rather than a profile comprised of a flat bottom portion 410 and sloping portions 415. FIG. 9C illustrates a third controller provided with an outer set of first buttons 480A with a second inner set of second buttons 480B. As such as a user tilts the third controller, the second button 480B is actuated but continued motion in the same direction subsequently results in the first button 480A being activated. Accordingly, the machine receiving the inputs from the third controller 400K may react differently if the second button 480B is activated than when first and second buttons 480A and 480B respectively are activated.

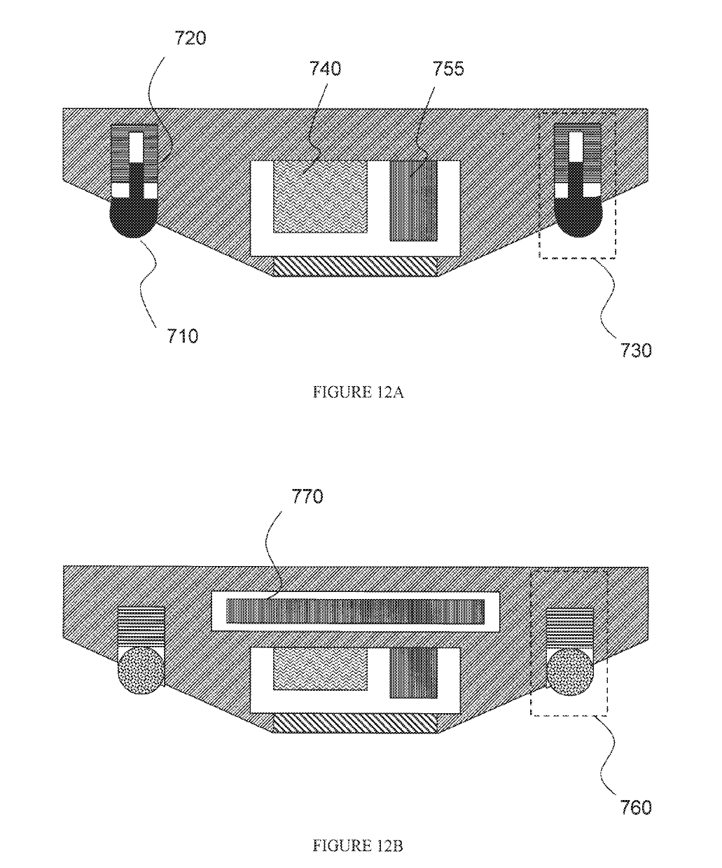

Referring to FIGS. 10A and 10B, there is depicted a controller pad or pedal controller 500 according to an embodiment with the addition of rotational motion detection. Controller pad 500 being shown as cross-section side elevation in FIG. 10A and plan view in FIG. 10B, wherein plan view follows section line Z-Z in cross-section side elevation. As shown in the cross-section side elevation, which is along section line X-X in the plan view, the controller pad 500 again comprises a base 525 which comprises a chamber 560 and a flat base portion 520. Also disposed within the base 525 are buttons 540 and sensors 545 that each form a movement sensor together with a respective button 540, and convert the contact of a button 540 with the receiving surface upon which the controller pad 500 is sitting to an electrical signal for the controller circuit 530 (which includes the communication that is disposed within the chamber 560. Controller circuit 530 then interfaces to interface circuit 535 to provide the determined events from the users motion of the controller pad 500 to the computer system executing an application that the user is controlling an aspect of performance. Also disposed within the chamber 560 are plate 515 that supports from it vertical stops 545 and pivot 505 that connects to the flat base portion 520. Also mounted to the pivot 505 is a rotor 510. According whilst the user may tilt controller pad 500 as described supra in respect of the controller pads in FIGS. 7A through 9C they may also twist the controller pad 500 wherein that motion is similarly communicated to the controller circuit 530 and thence to interface circuit 535.

Accordingly, it would be evident to one skilled in the art that such rotational control provides an additional degree of control for the user. The bottom surface of flat base portion 520 may be provided with either a single surface providing traction on both smooth hard surfaces, e.g. wood flooring, or soft rough surfaces such as carpet. Alternatively the flat base portion 520 may be swapped according to the surface on which the controller pad 500 will be used. Optionally, the vertical stops 545 which are disposed with respect to the rotor 510 and restrict the rotation of the rotor 510 may be removed allowing increased rotational motion control. It would be evident that as with the “buttons” different technologies may be used for the rotation sensor according to desired resolution, accuracy, speed etc. Solutions evident to one of skill in the art would include, but not be limited to, Hall effect sensors, rotary optical encoders, rotary variable capacitors, and rotary potentiometers.

Now referring to FIGS. 11A and 11B, there is depicted a controller pad or pedal controller 600 according to an embodiment with rotational sensor 660 and button sensor 670 control selection mechanisms. Additionally, the controller pad 600 has a location sensor 610 disposed across the top surface of the body 620. The controller pad 600 is shown as cross-section side elevation in FIG. 11A, and plan view in FIG. 11B. The core of controller pad 600 being for example provided by controller pad 500 as depicted in FIGS. 10A and 10B supra to provide the rotational sensor 660 and button sensor 670 control selection elements for the user. However, now the location sensor 710 disposed upon the top surface of the body 620 provides additional information to the electrical decision and control circuits 680 which contain the communication interface unit.

Location sensor 610 thereby provides different information to the electrical decision and control circuit 680 when the user foot (or other body part interacting with the controller pad) shifts position, for example between each of first to third locations 630 through 650 respectively. Hence, in addition to rotation (from the rotational sensor 660) and tilt movement (from the button sensor 670) movement of the users foot (for example) provides for side-stepping of their character in the virtual environment of the game they are playing or another function currently selected as being determined in dependence of this position information.

Referring to FIGS. 12A and 12B, there is depicted a controller pad or pedal controller 700 according to an embodiment wherein the button sensor, such as button sensor 670 in FIGS. 11A and 11B is replaced with a button displacement sensor 730. Accordingly, as the user tilts the controller pad 700 then initially the lower surface of the button plunger 710 engages the surface upon which the controller pad 700 is sitting. Now, continued tilting of the controller pad 700 will result in the button plunger 710 being displaced further into button housing 720 such that the linear motion of the button plunger 710 results in a continuously varying sensor output to the controller circuit 740 and thence to the machine being interfaced to the controller pad 700 via interface circuit 755. Accordingly, a user can by initially engaging the button displacement sensor 730 cause an initial action to occur, such as selecting acceleration, and by continuing to tilt the controller pad 700 cause increasing acceleration through increased tilting of the controller pad 700.

Also referring to FIGS. 12A and 12B, there is depicted tilt controller pad 750 according to an embodiment wherein there are provided button controls 760 for triggering specific actions based upon which button control 760 is activated. However, tilt controller pad 750 also includes a tilt sensor 770 that provides continuous tilt sensing prior to the button control 760 being activated at the tilt controller pad 750 touching the surface upon which it is mounted.

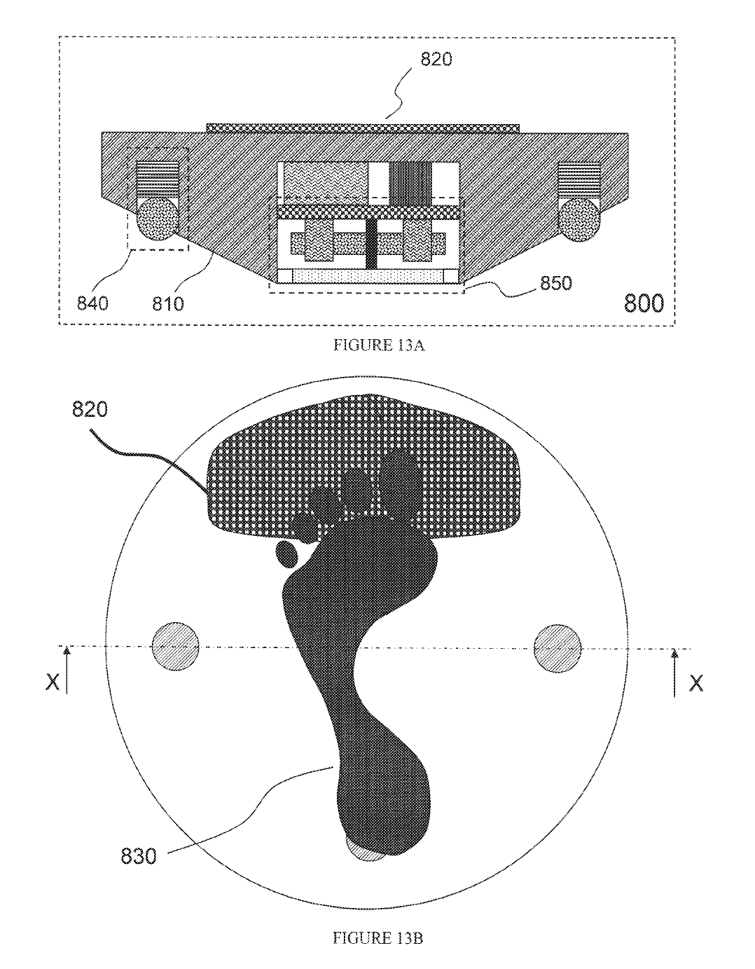

Now referring to FIGS. 13A and 13B, there is depicted a controller pad or pedal controller 800 according to an embodiment with rotational sensor 850 and button sensor 840 control selection mechanisms. Additionally, the controller pad 800 has a location sensor 820 disposed upon a predetermined portion of the top plate of the body 810. The controller pad 800 is shown as cross-section side elevation in FIG. 13A, and plan view in FIG. 13B. The core of the controller pad 800 being for example provided by controller 500 as depicted in FIGS. 10A and 10B supra to provide the rotational sensor 850 and button sensor 840 control selection elements for the user. However, now the location sensor 820 disposed upon the top plate 815 provides additional information to the electrical decision and control circuit (not shown for clarity).

The location sensor 820 thereby provides different information to the electrical decision and control circuit (or communication interface unit) when the users big toe, for example (or other body part interacting with the controller pad), shifts position relative to the location sensor 820 and when placed in contact with the location sensor 820 provides a different signal to the electrical decision and control circuit. Hence, in addition to rotation (from the rotation sensor 850) and selection (from the button sensor 840) movement of the users' big toe (for example) provides for side-stepping of their character in the virtual environment of the game they are playing or another function currently selected as being determined in dependence of this position information.

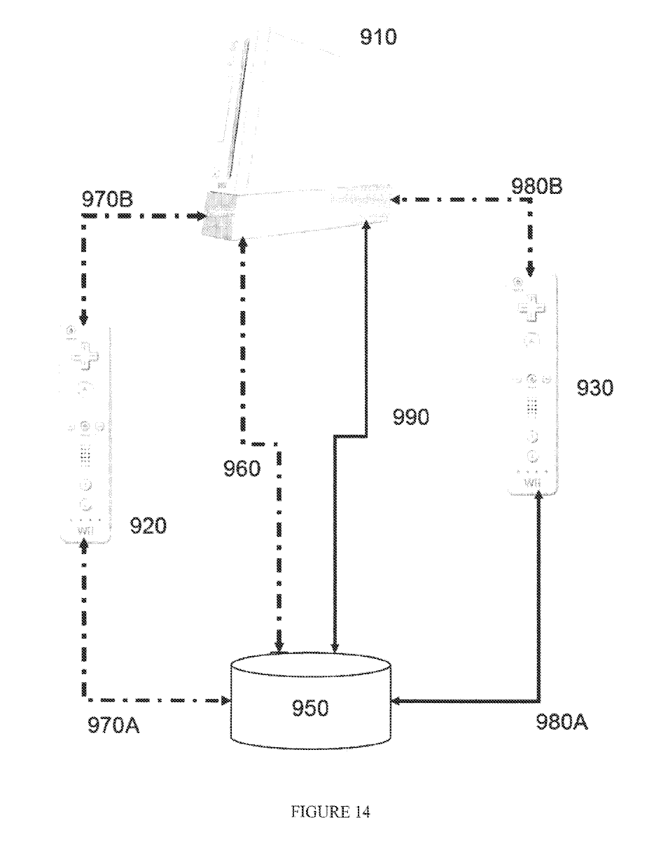

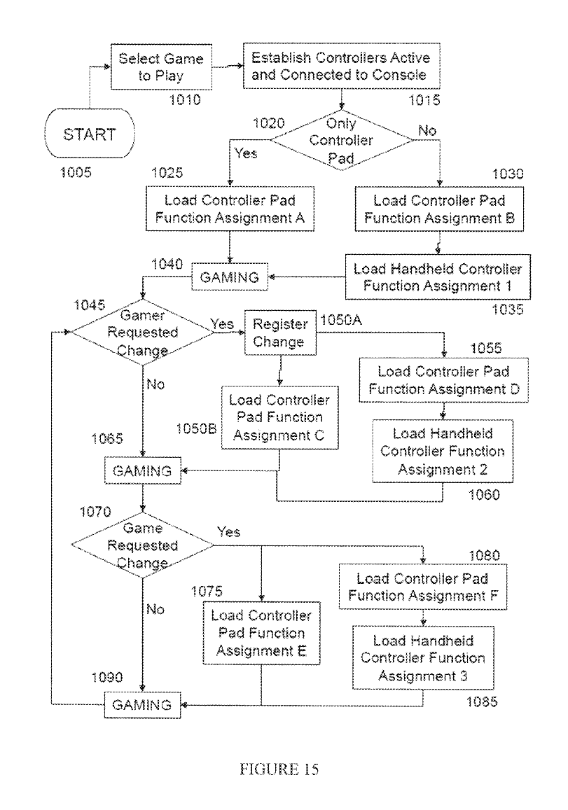

FIG. 14 illustrates some exemplary combinations of a controller pad 950 interfacing to a machine 910 such as a gaming console. Where the controller pad 950 supports a wireless interface as does the gaming console 910 then the two elements may communicate through a first wireless link 960. Alternatively, the controller pad 950 may be wirelessly connected to a first controller 920 through a second wireless link 970A and therein through to the gaming console 910 via a third wireless link 970B between the gaming console 910 and the first controller 920. Alternatively, the controller pad 950 may be connected to a second controller 930 through a first wired connection 980A and therein through to the gaming console 910 via a fourth wireless link 980B between the gaming console 910 and the second controller 930. Optionally, the controller pad 950 may be directly interfaced to the gaming console 910 through a second wired connection 990. It would also be apparent to one skilled in the art the either of the first or second controllers 920 and 930, respectively, may also be connected to the gaming console 910 by a wired connection rather than a wireless link. In this manner, the gaming console 910 may interact with the controller pad 950 in dependence upon whether the controller pad is directly interfaced or intermediately interfaced.

It would be apparent to one skilled in the art that whilst the controller pad has been considered within FIG. 14 as having wired or wireless interfaces, it may be implemented with both. In this embodiment a wired connection to a handheld controller or gaming console may override the detection of a wireless connection from the controller pad to either a handheld controller or gaming console. Alternatively, the wireless link may be set to take priority or the gamer be offered the option.

Within the embodiments presented supra in respect of FIGS. 7A through 14, the controller pad has been described as comprising multiple sensors for the detection of the motion of the controller pad with respect to the receiving surface and having either contacts or displacement sensors to provide control information to the computer system executing an application to which the controller pad is connected there is no provision of feedback to the user. It would be apparent that optionally the linear displacement sensors or buttons may be replaced or augmented with transducers that provide positive force to the controller plate by pushing against the surface on which the controller pad is sitting. For example, when a character jumps and lands within the gaming environment then the transducers may provide a pulse to the controller pad giving the user the sensation of their feet hitting the ground. Optionally, these transducers may provide force to the controller pad as well as providing the determination of the user's actions thereby combining multiple elements within single piece parts. In applications where the user is employing the controller pad alone, such as an individual with a disability, then the transducers may provide feedback for other events such as them swinging their sword and hitting an opponent's weapon, body etc, providing an indication that an activity is not allowed, such as vibrating with an illegal selection of an option in a drop-down menu selection in a computer application, giving physical feedback of a spelling error requiring correction etc.

Within the embodiments, the electrical decision and control circuit or communication interface unit has been stated as present within the controller pad. The functions of the electrical decision and control circuit being to apply any required power to the sensor elements, e.g. “buttons”, rotation sensor, linear motion sensor, force transducers etc. Additionally, the electrical decision and control circuit may receive the signals from these transducers and determine a position, rotation, action for communication to the handheld controller or gaming interface. The electrical decision and control circuit also contains communications interfaces such as for the wired interface or wireless interface. Optionally the electrical decision and control circuit may contain other elements such as microprocessors, visual indicators, etc. It would be apparent to one skilled in the art that the electrical decision and control circuit may be provided as a single circuit within the controller pad or as multiple distributed circuits within the controller pad, although optionally some elements such as decision determination may be provided within the handheld controller or gaming console to which the controller pad is interfaced.

Now referring to FIG. 15, there is presented an exemplary flow chart for a gaming console interacting with a controller pad or pedal controller according to an embodiment. The process begins at step 1005 wherein the gaming console is powered up and then in step 1010 the user selects the game they wish to play. At step 1015, the gaming console determines the controller hardware currently interfaced to the gaming console and determines, at step 1020, whether the controller pad is present alone or in combination with another controller, e.g. a hand-held controller. If the controller pad is the only device present, then the process moves to step 1025 and the controller pad function assignment A is loaded into the gaming console and the process moves to step 1040 for gaming to begin. If the control pad is not the only device present, then the process moves to step 1030 wherein the controller pad function assignment B is loaded and then the process moves to step wherein the handheld controller function assignment 1 is loaded and the process moves to step 1040. From step 1040, the process during gaming, which executes simultaneously but is not shown for clarity the game moves to step 1045.

During gaming, the gaming console monitors for trigger events that relate to either to a change of functions requested by the gamer/user or by the game itself. In process step 1045, the process determines whether a gamer requested change was initiated or not. If there was no gamer requested change, then the process moves to step 1065 and gaming continues. If there was a gamer requested change and the gaming console had previously determined the controller pad was the only controller present, then the process moves forward to step 1050A to determine what change the gamer requires and therein moves forward to step 1050B and loads controller pad assignment C before moving forward to step 1065 wherein gaming continues. If there was a gamer requested change and the gaming console had previously determined the controller pad was being used in conjunction with a handheld controller, then the process moves forward to step 1055, loads controller pad assignment D, moves to step 1060, loads handheld controller function assignment 2, before moving forward to step 1065 wherein gaming continues.

From step 1065, the process moves forward to step 1070 to determine whether a change of function request was initiated by the game. If there was no game requested change then the process moves to step 1090 and gaming continues. If there was a game requested change and the gaming console had previously determined the controller pad was the only controller present, then the process moves forward to step 1075 and loads controller pad assignment E before moving forward to step 1090 wherein gaming continues. If there was a gamer requested change and the gaming console had previously determined the controller pad was being used in conjunction with a handheld controller, then the process moves forward to step 1080, loads controller pad assignment F, moves to step 1085, loads handheld controller function assignment 3, and moves forward to step 1090 wherein gaming continues. From step 1090, the process loops back to step 1045 to determine whether additional gamer or game triggered changes in function assignments are requested. It would evident to one skilled in the art that the exemplary flow chart is only part of an overall gaming flow chart and has been considerably simplified to focus on the controller function assignments only.

It would be evident to one skilled in the art that other process flows may be configured with other steps and decision points. These alternative process flows similarly result in the assignment of the “buttons” and other functions of the controller pad may be dynamically allocated by actions of the gamer (user) or in response to variations of the gaming environment. For example, a character walking results in the 4 “buttons” on a controller, i.e. controller pad 400 in FIG. 7A, providing forward, back, left step, right step when the character is within one environment, e.g. inside a building, and accelerate, brake, no action, no action when the character is within another environment, e.g. in a vehicle.

In the embodiments described above in respect of FIGS. 10A through 13B, “buttons” are presented with the configuration as that of controller pad 400 in FIG. 9A. It would be apparent to one skilled in the art that the configurations presented in respect of controller pads in FIGS. 7A and 8A may be employed in these or alternatively any configuration determined by the designer. Optionally, different “buttons” may be implemented with different technologies within the same controller pad, for example linear transduction buttons may be used for forward/backward tilting whilst simple button sensors light be employed for left/right tilting. It would also be apparent that whilst in the embodiments the controller pad has been presented with a base that has a flat portion or curved base that the design of the controller pad may exploit other shapes such as non-planar sidewalls with different radius to the curved bottom portion or that the sidewalls are convex/planar and the central base portion is concave. Additionally, the design of the controller pad may be other than the circular designs within the embodiments described supra in respect of FIGS. 7A through 15 including for example designs that are square, hand shaped, foot shaped, etc. Additionally, the size of the controller pads may be varied, for example a unit of dimensions 75 mm/100 mm (3″/4″) may be used with a users hand whilst another of say 150 mm/200 mm (6″/8″) may form one for use with a user's foot. Alternatively, the controller pad may include a handle disposed upon the top surface allowing the user to engage the controller pad for example with their fingers, or a pointer and acting in a manner to provide joystick functionality to the user.

Within the embodiments described supra in respect of FIGS. 7A through 15, the applications of the controller pad have been described with respect of gaming environments and gaming consoles. However, it would be apparent to one skilled in the art that the controller pads may be employed within a wide variety of computer, console, and gaming based systems to provide a haptic interface for users. As discussed these controller pads may be employed in conjunction with conventional handheld controllers or they may be employed discretely. In discrete applications, they may provide an interface for those with disabilities whom have previously not been able to enjoy the gaming and entertainment services of these systems. As such, the controller pad may provide the functions of other interface devices such computer mouse, keyboard, tablet, etc to such users.

In the embodiments described supra in respect of FIGS. 7A through 15, the applications of the controller pad have been described in respect of influencing an aspect of a software application. Optionally, in some applications the control data/control signals from the controller pad may be adjusted prior to communication from the controller pad in dependence upon input data provided to the controller pad from the software application in execution upon a gaming console or other microprocessor based device.

The embodiments of the invention described above are intended to be exemplary only. The scope of the invention is therefore intended to be limited solely by the scope of the appended claims.

1. A foot-operated controller for controlling a machine, comprising:
a foot-receiving platform comprising a foot-receiving member and a base to be deposited on a receiving surface, the foot-receiving member having a first member end for receiving a foot of a user and a second member end opposite to the first member end, the base protruding from the second member end of the foot-receiving member, the base and the receiving surface forming a pivot joint for rocking the foot-receiving platform relative to the receiving surface in at least one direction;
at least one sensor for detecting at least one rocking movement of the foot-receiving platform relative to the receiving surface in the at least one direction; and
a communication interface unit secured to the foot-receiving platform and operatively connected to the at least one sensor for transmitting to the machine a respective command upon detection of the at least one rocking movement, the foot-operated controller being connectable to a power source for powering at least the at least one sensor.

2. The foot-operated controller of claim 1, wherein the at least one sensor comprises a single position sensor integrated within the foot-receiving platform for detecting one of a position and a position variation for a reference point of the foot-receiving platform.

3. The foot-operated controller of claim 1, wherein the at least one sensor comprises a plurality of switches each located at a different location on the foot-receiving platform and each activatable upon a corresponding one of the at least one rocking movement of the foot-receiving platform in a corresponding one of the at least one direction.

4. The foot-operated controller of claim 3, wherein the plurality of switches each protrude from the second member end of the foot-receiving member.

5. The foot-operated controller of claim 3, wherein the plurality of switches each protrude from the base of the foot-receiving member.

6. The foot-operated controller of claim 3, wherein each one of the plurality of switches comprises a push button switch activatable upon abutment on the receiving surface.

7. The foot-operated controller of claim 1, further comprising at least one elastic member having one end secured to one of the base and the foot-receiving member and an opposite end to rest on the receiving surface.

8. The foot-operated controller of claim 7, wherein the at least one elastic member comprises at least one spring.

9. The foot-operated controller of claim 1, wherein a cross-sectional surface area of the base decreases from the second member end of the foot-receiving member.

10. The foot-operated controller of claim 9, wherein the base has a hemispherical shape.

11. The foot-operated controller of claim 1, wherein the respective command is indicative of a discrete input for the machine.

12. The foot-operated controller of claim 1, wherein the respective command is indicative of a continuous input for the machine.

13. The foot-operated controller of claim 1, wherein the communication interface unit comprises a processing unit, a storing unit, and communication means.

14. The foot-operated controller of claim 13, wherein the communication means comprises a connector.

15. The foot-operated controller of claim 13, wherein the communication means comprises a wireless communication device.

16. The foot-operated controller of claim 13, wherein the storing unit is adapted to store thereon a database comprising one of a corresponding code and a corresponding macro for each one of the at least one direction, the processing unit being configured for transmitting the one of a corresponding code and a corresponding macro upon detection of at the least one rocking movement of the foot-receiving platform via the communication means.

17. A foot-operated controller for controlling a machine, comprising:
a rockable platform for receiving a foot of a user and to be deposited on a receiving surface, the rockable platform being movable between a default position and at least one tilted position relative to the receiving surface;
at least one sensor secured to the rockable platform for detecting the at least one tilted position of the foot-receiving platform; and
a communication interface unit integrated within the rockable platform and operatively connected to the at least one sensor for transmitting to the machine a respective command upon detection of the at least one tilted position, the foot-operated controller being connectable to a power source for powering at least the at least one sensor.

18. The foot-operated controller of claim 17, wherein the at least one sensor comprises a plurality of switches each for detecting a respective one of the at least one tilted position.

19. The foot-operated controller of claim 18, wherein the communication interface unit is adapted to transmit a corresponding switch identification upon activation of the switches.

20. The foot-operated controller of claim 18, wherein the communication interface unit is adapted to transmit one of a corresponding code and a corresponding macro upon activation of the switches.
